(19) United States
(12) Patent Application Publication
(10) Pub. No.: US 2013/0176726 A1
(43) Pub. Date: Jul. 11, 2013

(54) LED HEAT DISSIPATION DEVICE HAVING AXIAL AND RADIAL CONVECTION HOLES

(71) Applicant: Tai-Her YANG, Dzan-Hwa (TW)

(72) Inventor: Tai-Her YANG, Dzan-Hwa (TW)

(21) Appl. No.: 13/345,848

(22) Filed: Jan. 9, 2012

(51) Int. Cl. F21V 29/00; F21V 7/00; F21V 5/00

(52) U.S. Cl. 362/235; 362/382

(57) ABSTRACT

The present invention provides a LED heat dissipation device having axial and radial convection holes for meeting the heat dissipation requirement of a light emitting diode (LED), so the heat dissipation device is not only equipped with a function of dissipating heat to the exterior through the surface of the heat dissipation device, but also provided with the air flowing capable of assisting heat dissipation through the hot airflow in a heat dissipation member having axial and radial convection holes (101) generating a hot ascent/cold descent effect for introducing airflow from an air inlet port formed near a light projection side to pass an axial tubular flowpath (102) then be discharged from a radial air outlet hole (107) formed near a connection side (104) of the heat dissipation member having axial and radial convection holes (101).

### BACKGROUND OF THE INVENTION

(a) Field of the Invention

The present invention provides a LED heat dissipation device having axial and radial convection holes for meeting the heat dissipation requirement of a light emitting diode (LED), so the heat dissipation device is not only equipped with a function of dissipating heat to the exterior through the surface of the heat dissipation device, but also provided with the air flowing capable of assisting heat dissipation through the hot airflow in a heat dissipation member having axial and radial convection holes (101) generating a hot ascent/cold descent effect for introducing airflow from an air inlet port formed near a light projection side to pass an axial tubular flowpath (102) then be discharged from a radial air outlet hole (107) formed near a connection side (104) of the heat dissipation member having axial and radial convection holes (101).

(b) Description of the Prior Art

A conventional LED heat dissipation device generally transmits the thermal energy of LED to the heat dissipation device for discharging heat to the exterior through the surface of the heat dissipation device, and said conventional LED heat dissipation device is not provided with an inner heat dissipation surface formed by axial holes for utilizing the airflow from an air inlet port passing the inner heat dissipation surface formed by the axial holes for discharging heat to the exterior through a radial air outlet hole. The present invention is provided with an axial hole formed on an axial tubular flowpath (102) fabricated in a heat dissipation member having axial and radial convection holes (101), so the airflow from an air inlet part can be used for discharging the hot airflow in the axial hole to the exterior through a radial air outlet hole; therefore beside the surface of the heat dissipation device used for dissipating heat to the exterior, the present invention is provided with the air flowing capable of assisting heat dissipation through the hot airflow in a heat dissipation member having axial and radial convection holes (101) generating a hot ascent/cold descent effect for introducing airflow from an air inlet port formed near a light projection side to pass an axial tubular flowpath (102) then be discharged from a radial air outlet hole (107) formed near a connection side (104) of the heat dissipation member having axial and radial convection holes (101).

### SUMMARY OF THE INVENTION

A conventional LED heat dissipation device generally transmits the thermal energy of LED to the heat dissipation device for discharging heat to the exterior through the surface of the heat dissipation device, and said conventional LED heat dissipation device is not provided with an inner heat dissipation surface formed by axial holes for utilizing the airflow from an air inlet port passing the inner heat dissipation surface formed by the axial holes for discharging heat to the exterior through a radial air outlet hole. The present invention provides a LED heat dissipation device having axial and radial convection holes for meeting the heat dissipation requirement of a light emitting diode (LED), an axial hole is formed on an axial tubular flowpath (102) fabricated in a heat dissipation member having axial and radial convection holes (101), so the airflow from an air inlet part can be used for discharging the hot airflow in the axial hole to the exterior through a radial air outlet hole; therefore beside the surface of the heat dissipation device used for dissipating heat to the exterior, the present invention is provided with the air flowing capable of assisting heat dissipation through the hot airflow in a heat dissipation member having axial and radial convection holes (101) generating a hot ascent/cold descent effect for introducing airflow from an air inlet port formed near a light projection side to pass an axial tubular flowpath (102) then be discharged from a radial air outlet hole (107) formed near a connection side (104) of the heat dissipation member having axial and radial convection holes (101).

### BRIEF DESCRIPTION OF THE DRAWINGS

FIG. 1 is a schematic view showing the basic structure and operation of the present invention.

FIG. 2 is a cross sectional view of FIG. 1 taken from A-A cross section.

FIG. 3 is a schematic structural view illustrating an electric-powered light emitting unit being installed at the center of the end surface of a light projection side and a radial air inlet port (108) being formed near the outer periphery of the light projection side, according to one embodiment of the present invention.

FIG. 4 is a top view of FIG. 3.

FIG. 5 is a schematic structural view illustrating the electric-powered light emitting unit being annularly installed near the outer periphery of the light projection side and the center being formed with a central axial air inlet port (109), according to one embodiment of the present invention.

FIG. 6 is a top view of FIG. 5.

FIG. 7 is a schematic structural view illustrating the electric-powered light emitting unit being annularly installed near the inner periphery of the light projection side and the center being formed with a central axial air inlet port (109), according to one embodiment of the present invention.

FIG. 8 is a top view of FIG. 7.

FIG. 9 is a schematic structural view illustrating the electric-powered light emitting unit being installed at the center of the end surface of the light projection side and the light projection side being formed with an air inlet port annularly arranged near the periphery of axial end surface (110), according to one embodiment of the present invention.

FIG. 10 is a top view of FIG. 9.

FIG. 11 is a schematic structural view illustrating the embodiment disclosed in FIG. 3 being applied in a heat dissipation member having axial and radial convection holes (101) having the top being installed with a radially-fixed and electric conductive interface (115) and installed with a top cover member (116), according to one embodiment of the present invention.

FIG. 12 is a bottom view of FIG. 11.

FIG. 13 is a schematic structural view illustrating the embodiment disclosed in FIG. 5 being applied in the heat dissipation member having axial and radial convection holes (101) having the top being installed with a radially-fixed and electric conductive interface (115) and installed with a top cover member (116), according to one embodiment of the present invention.

FIG. 14 is a bottom view of FIG. 13.

FIG. 15 is a schematic structural view illustrating the embodiment disclosed in FIG. 7 being applied in the heat dissipation member having axial and radial convection holes (101) having the top being installed with a radially-fixed and electric conductive interface (115) and installed with a top cover member (116), according to one embodiment of the present invention.

FIG. 16 is a bottom view of FIG. 15.

FIG. 17 is a schematic structural view illustrating the embodiment disclosed in FIG. 9 being applied in the heat dissipation member having axial and radial convection holes (101) having the top being installed with a radially-fixed and electric conductive interface (115) and installed with a top cover member (116), according to one embodiment of the present invention.

FIG. 18 is a bottom view of FIG. 17.

FIG. 19 is a schematic view illustrating the axial A-A cross section of the axial tubular flowpath (102) shown in FIG. 1 being formed as an oval hole, according to one embodiment of the present invention.

FIG. 20 is a schematic view illustrating the axial A-A cross section of the axial tubular flowpath (102) shown in FIG. 1 being formed as a triangular hole, according to one embodiment of the present invention.

FIG. 21 is a schematic view illustrating the axial A-A cross section of the axial tubular flowpath (102) shown in FIG. 1 being formed as a rectangular hole, according to one embodiment of the present invention.

FIG. 22 is a schematic view illustrating the axial A-A cross section of the axial tubular flowpath (102) shown in FIG. 1 being formed as a pentagonal hole, according to one embodiment of the present invention.

FIG. 23 is a schematic view illustrating the axial A-A cross section of the axial tubular flowpath (102) shown in FIG. 1 being formed as a hexagonal hole, according to one embodiment of the present invention.

FIG. 24 is a schematic view illustrating the axial A-A cross section of the axial tubular flowpath (102) shown in FIG. 1 being formed as a U-shaped hole, according to one embodiment of the present invention.

FIG. 25 is a schematic view illustrating the axial A-A cross section of the axial tubular flowpath (102) shown in FIG. 1 being formed as a singular-slot hole with dual open ends, according to one embodiment of the present invention.

FIG. 26 is a schematic view illustrating the axial A-A cross section of the axial tubular flowpath (102) shown in FIG. 1 being formed as a multiple-slot hole with dual open ends, according to one embodiment of the present invention.

FIG. 27 is a schematic view illustrating the axial B-B cross section of the axial tubular flowpath (102) shown in FIG. 1 being formed as a heat dissipation fin structure (200), according to one embodiment of the present invention.

FIG. 28 is a schematic view showing the heat dissipation member having axial and radial convection holes (101) being formed as a porous structure, according to one embodiment of the present invention.

FIG. 29 is a schematic view showing the heat dissipation member having axial and radial convection holes (101) being formed as a net-shaped structure, according to one embodiment of the present invention.

FIG. 30 is a schematic view illustrating an electric motor driven fan (300) being provided in the interior, according to one embodiment of the present invention.

### DESCRIPTION OF MAIN COMPONENT SYMBOLS

(101) Heat dissipation member having axial and radial convection holes
(102): Axial tubular flowpath
(103): Light projection side
(104): Connection side
(105): External heat dissipation surface
(106): Internal heat dissipation surface
(107): Radial air outlet hole
(108): Radial air inlet port
(109): Central axial air inlet port
(110): Air inlet port annularly arranged near the periphery of axial end surface
(111): Light emitting diode
(112): Secondary optical device
(113): Light-pervious lampshade
(114): Axially-fixed and electric-conductive interface
(115): Radially-fixed and electric-conductive interface
(116): Top cover member
(200): Heat dissipation fin structure
(300): Electric motor driven fan

### DETAILED DESCRIPTION OF THE PREFERRED EMBODIMENTS

A conventional LED heat dissipation device generally transmits the thermal energy of LED to the heat dissipation device for discharging heat to the exterior through the surface of the heat dissipation device, and said conventional LED heat dissipation device is not provided with an inner heat dissipation surface formed by axial holes for utilizing the airflow from an air inlet port passing the inner heat dissipation surface formed by the axial holes for discharging heat to the exterior through a radial air outlet hole. The present invention is provided with an axial hole formed on an axial tubular flowpath (102) fabricated in a heat dissipation member having axial and radial convection holes (101), so the airflow from an air inlet part can be used for discharging the hot airflow in the axial hole to the exterior through a radial air outlet hole; therefore beside the surface of the heat dissipation device used for dissipating heat to the exterior, the present invention is provided with the air flowing capable of assisting heat dissipation through the hot airflow in a heat dissipation member having axial and radial convection holes (101) generating a hot ascent/cold descent effect for introducing airflow from an air inlet port formed near a light projection side to pass an axial tubular flowpath (102) then be discharged from a radial air outlet hole (107) formed near a connection side (104) of the heat dissipation member having axial and radial convection holes (101).

The present invention provides a LED heat dissipation device having axial and radial convection holes for meeting the heat dissipation requirement of a light emitting diode (LED), so the heat dissipation device is not only equipped with a function of dissipating heat to the exterior through the surface of the heat dissipation device, but also provided with the air flowing capable of assisting heat dissipation through the hot airflow in a heat dissipation member having axial and radial convection holes (101) generating a hot ascent/cold descent effect for introducing airflow from an air inlet port formed near a light projection side to pass an axial tubular flowpath (102) then be discharged from a radial air outlet hole (107) formed near a connection side (104) of the heat dissipation member having axial and radial convection holes (101).

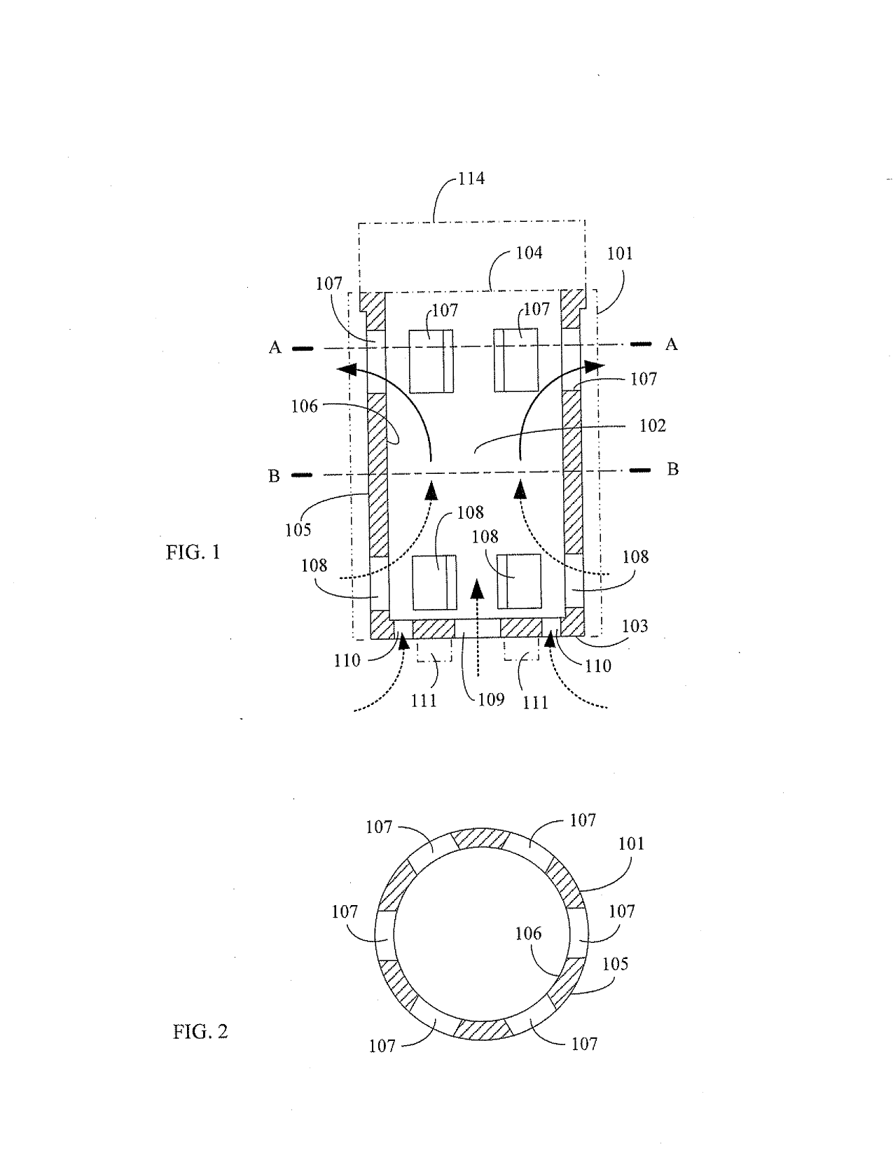

FIG. 1 is a schematic view showing the basic structure and operation of the present invention;

FIG. 2 is a cross sectional view of FIG. 1 taken from A-A cross section;

As shown in FIG. 1 and FIG. 2, it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and the light projection side (103) is installed with one or more than one air inlet ports, said air inlet ports are installed to at least one or more than one of three locations which include the outer periphery being installed with a radial air inlet port (108) and/or the center of axial end surface of the light projection side (103) being installed with a central axial air inlet port (109) and/or the light projection side (103) being installed with an air inlet port annularly arranged near the periphery of axial end surface (110);

With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the air inlet port formed near the light projection side to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior.

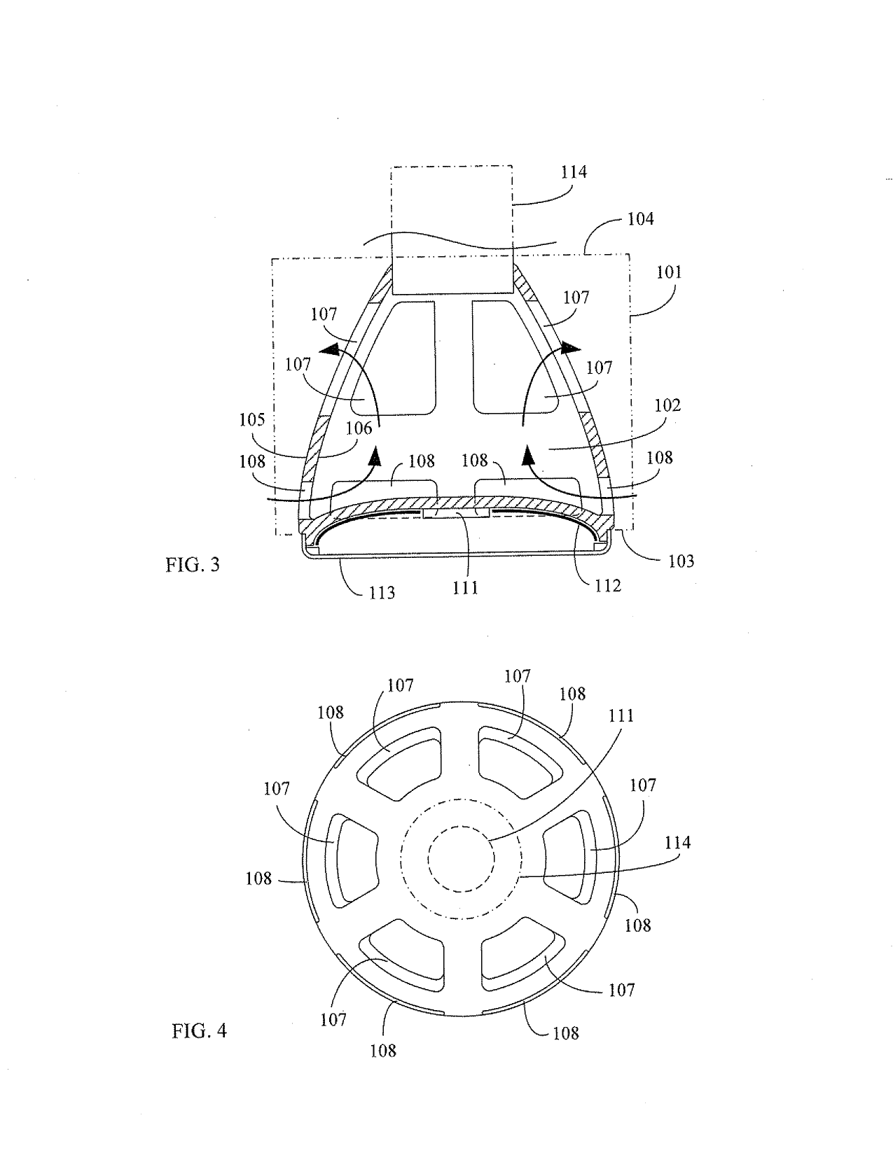

FIG. 3 is a schematic structural view illustrating an electric-powered light emitting unit being installed at the center of the end surface of a light projection side and a radial air inlet port (108) being formed near the outer periphery of the light projection side, according to one embodiment of the present invention;

FIG. 4 is a top view of FIG. 3;

As shown in FIG. 3 and FIG. 4, it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;

With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from one or more than one radial air inlet ports (108) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the center of the light projection side (103) of the heat dissipation member having axial and radial convection holes (101);
radial air inlet port (108): constituted by one or more than one radial air inlet ports (108) installed near the outer periphery of the light projection side (103) of the heat dissipation member having axial and radial convection holes (101), and said radial air inlet port (108) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
axially-fixed and electric-conductive interface (114): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and an axial external electric power, and connected to the LED (111) with an electric conductive member for transmitting electric power.

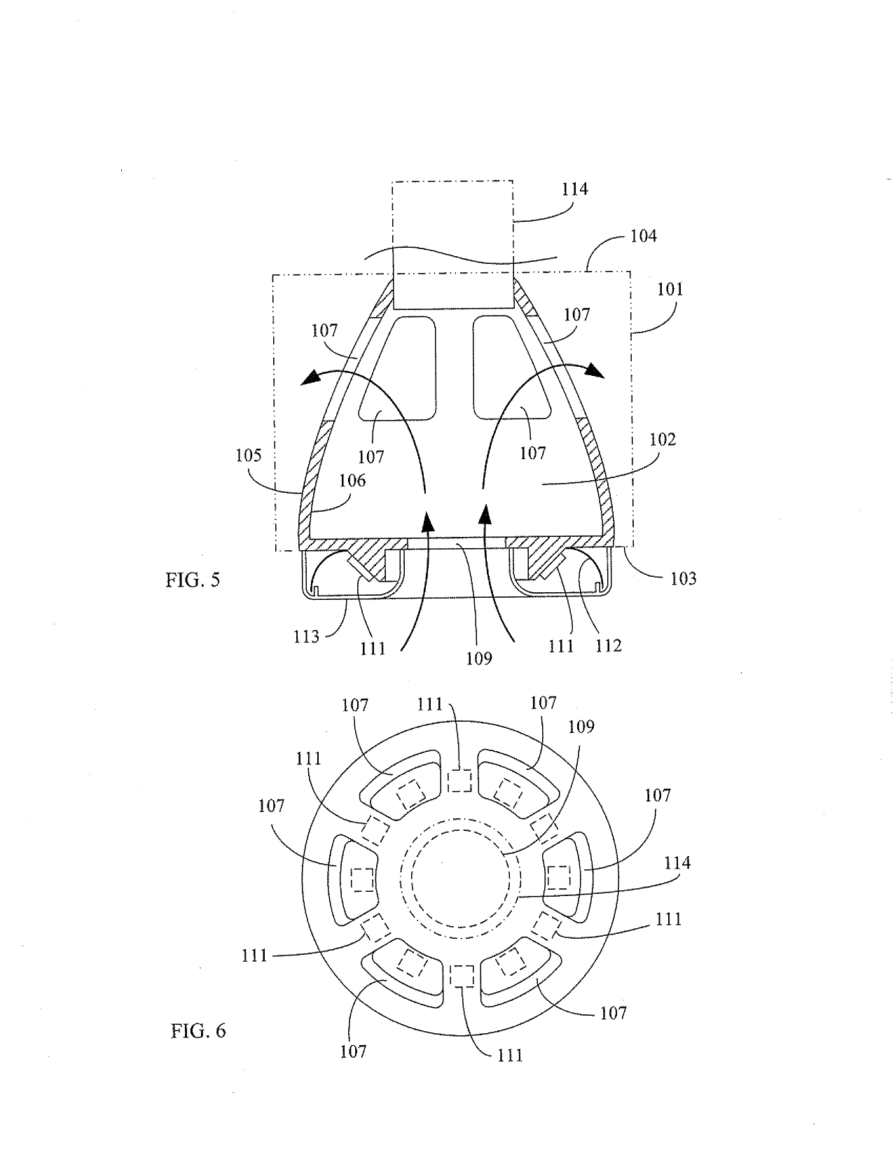

FIG. 5 is a schematic structural view illustrating the electric-powered light emitting unit being annularly installed near the outer periphery of the light projection side and the center being formed with a central axial air inlet port (109), according to one embodiment of the present invention;

FIG. 6 is a top view of FIG. 5;

As shown in FIG. 5 and FIG. 6, it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;

With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the central axial air inlet port (109) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the outer periphery of the light projection side (103) of the heat dissipation member having axial and radial convection holes (101);
central axial air inlet port (109): constituted by a central axial air inlet port structure installed on the axial end surface of the light projection side (103) of the heat dissipation member having axial and radial convection holes (101) for communicating to the axial tubular flowpath (102), and said central axial air inlet port (109) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
axially-fixed and electric-conductive interface (114): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and an axial external electric power, and connected to the LED (111) with an electric conductive member for transmitting electric power.

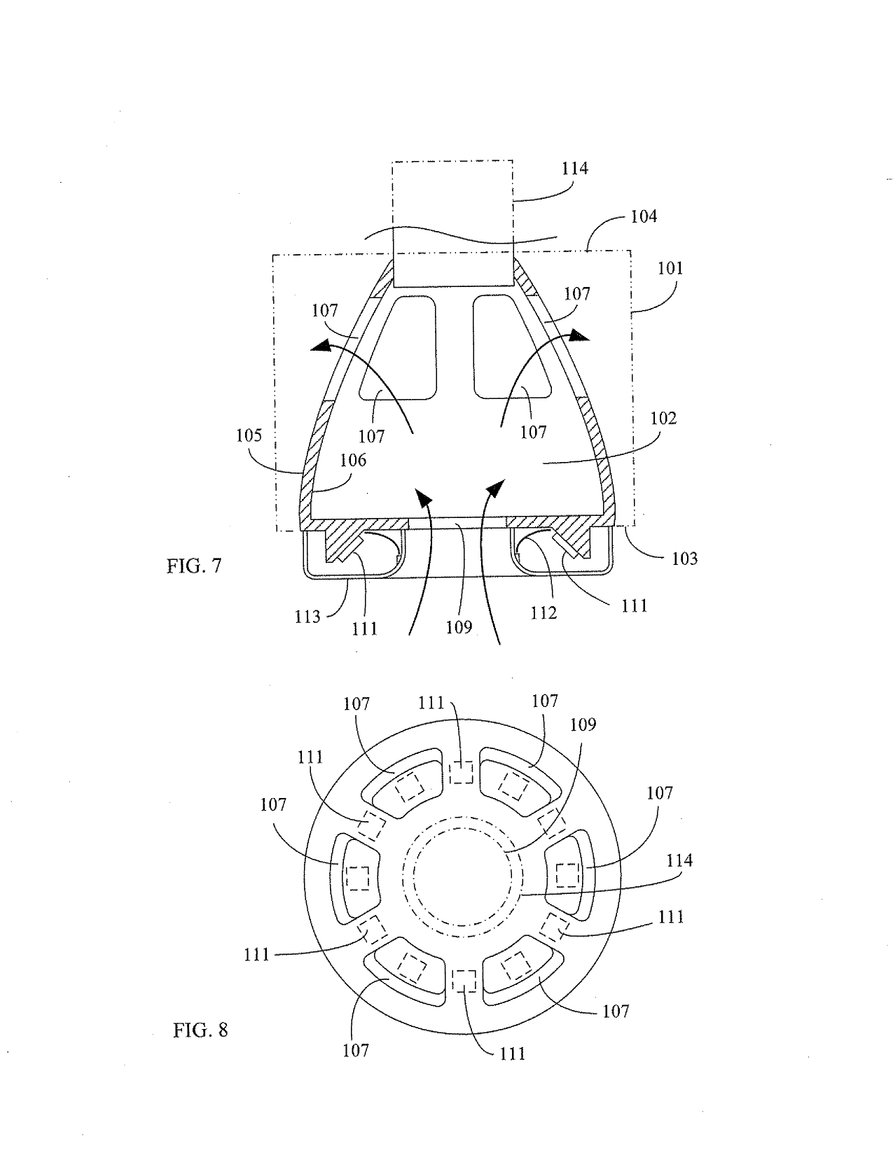

FIG. 7 is a schematic structural view illustrating the electric-powered light emitting unit being annularly installed near the inner periphery of the light projection side and the center being formed with a central axial air inlet port (109), according to one embodiment of the present invention;

FIG. 8 is a top view of FIG. 7;

As shown in FIG. 7 and FIG. 8, it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;

With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the central axial air inlet port (109) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the inner periphery of the light projection side (103) of the heat dissipation member having axial and radial convection holes (101);
central axial air inlet port (109): constituted by a central axial air inlet port structure installed on the axial end surface of the light projection side (103) of the heat dissipation member having axial and radial convection holes (101) for communicating to the axial tubular flowpath (102), and said central axial air inlet port (109) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
axially-fixed and electric-conductive interface (114): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and an axial external electric power, and connected to the LED (111) with an electric conductive member for transmitting electric power.

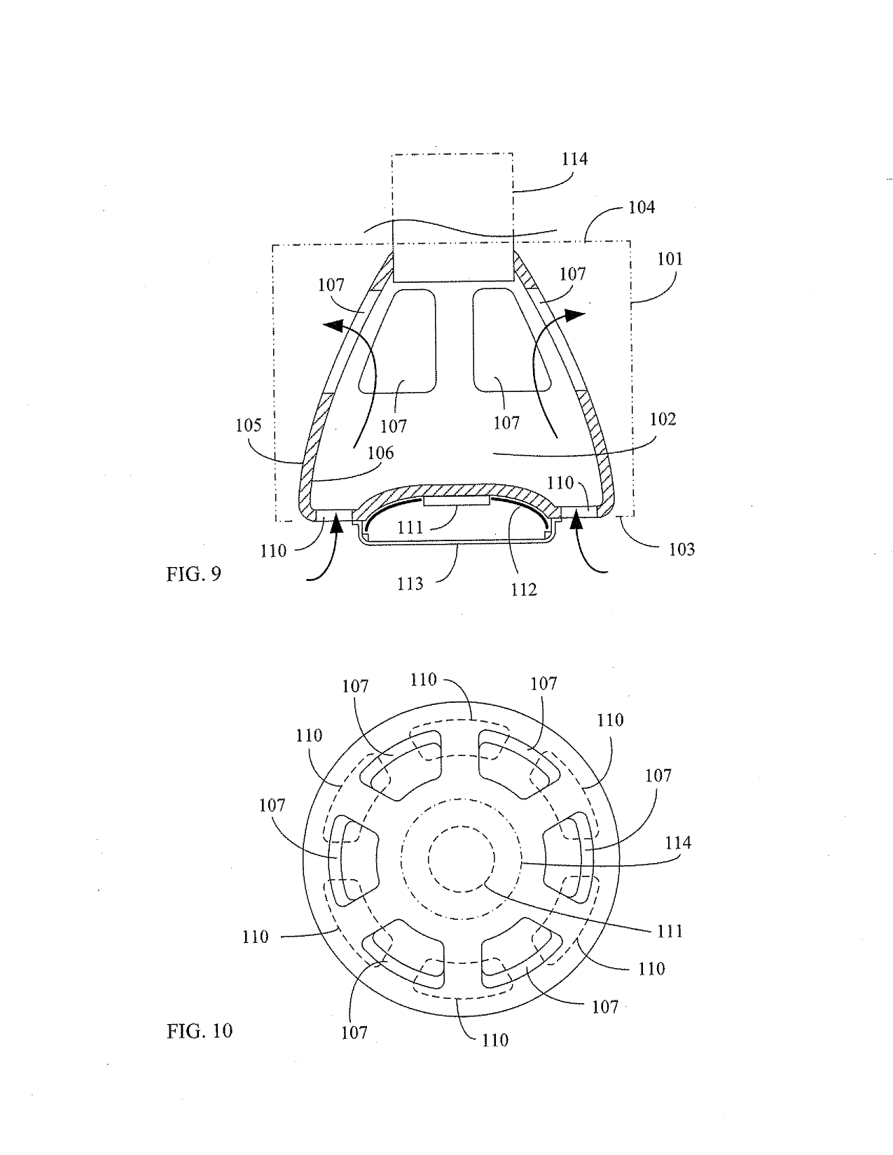

FIG. 9 is a schematic structural view illustrating the electric-powered light emitting unit being installed at the center of the end surface of the light projection side and the light projection side being formed with an air inlet port annularly arranged near the periphery of axial end surface (110), according to one embodiment of the present invention;

FIG. 10 is a top view of FIG. 9;

As shown in FIG. 9 and FIG. 10, it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;

With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from one or more than one air inlet ports annularly arranged near the periphery of axial end surface (110) at the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the center of the light projection side (103) of the heat dissipation member having axial and radial convection holes (101);
air inlet port annularly arranged near the periphery of axial end surface (110): constituted by one or more than one air inlet port structures annularly installed near the periphery of axial end surface of the light projection side (103) of the heat dissipation member having axial and radial convection holes (101) for communicating to the axial tubular flowpath (102), and said air inlet port annularly arranged near the periphery of axial end surface (110) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
axially-fixed and electric-conductive interface (114): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and an axial external electric power, and connected to the LED (111) with an electric conductive member for transmitting electric power.

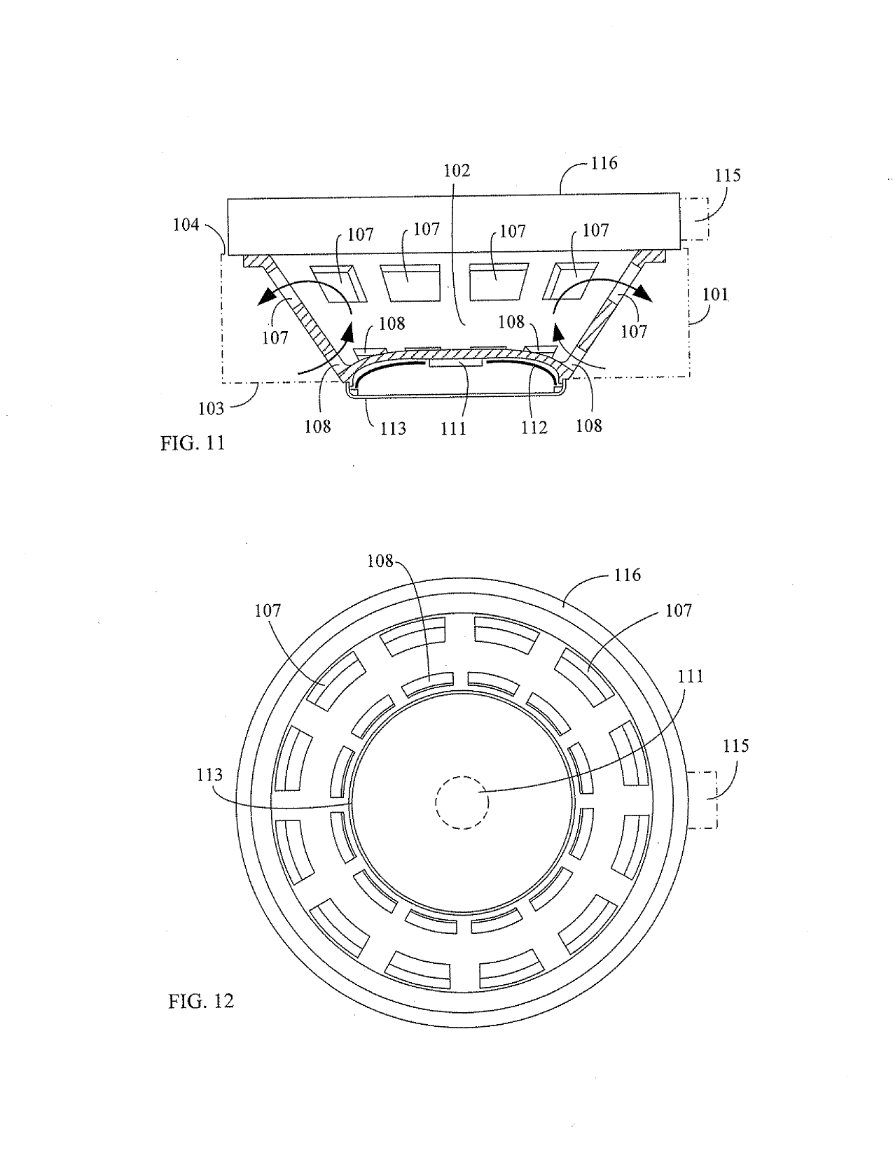

FIG. 11 is a schematic structural view illustrating the embodiment disclosed in FIG. 3 being applied in a heat dissipation member having axial and radial convection holes (101) having the top being installed with a radially-fixed and electric conductive interface (115) and installed with a top cover member (116), according to one embodiment of the present invention;

FIG. 12 is a bottom view of FIG. 11;

As shown in FIG. 11 and FIG. 12, it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;

With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from one or more than one radial air inlet ports (108) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the center of the light projection side (103) of the heat dissipation member having axial and radial convection holes (101);
radial air inlet port (108): constituted by one or more than one radial air inlet ports (108) installed near the outer periphery of the light projection side (103) of the heat dissipation member having axial and radial convection holes (101), and said radial air inlet port (108) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
radially-fixed and electric-conductive interface (115): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and a radial external electric power, and connected to the LED (111) with an electric conductive member for transmitting electric power;
top cover member (116): made of a thermal conductive or non thermal conductive material, connected at the connection side (104) of the heat dissipation member having axial and radial convection holes (101) for providing insulation and protection to the heat dissipation member having axial and radial convection holes (101), or providing functions of optical reflecting or refracting or condensing or diffusing; when being made of a thermal conductive material, the top cover member (116) further provides with a function of assisting the heat dissipation of the heat dissipation member having axial and radial convection holes (101).

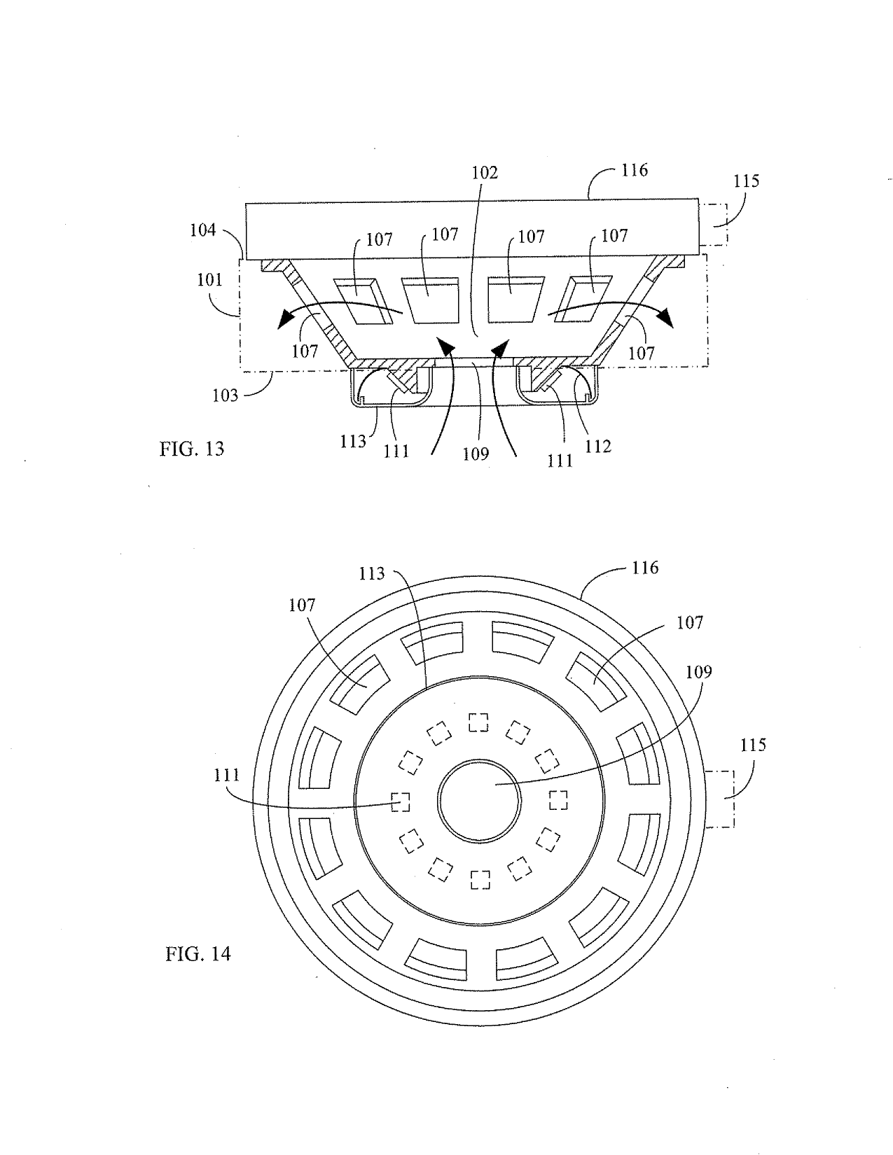

FIG. 13 is a schematic structural view illustrating the embodiment disclosed in FIG. 5 being applied in the heat dissipation member having axial and radial convection holes (101) having the top being installed with a radially-fixed and electric conductive interface (115) and installed with a top cover member (116), according to one embodiment of the present invention;

FIG. 14 is a bottom view of FIG. 13;

As shown in FIG. 13 and FIG. 14, it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;

With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the central axial air inlet port (109) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the outer periphery of the light projection side (103) of the heat dissipation member having axial and radial convection holes (101);
central axial air inlet port (109): constituted by a central axial air inlet port structure installed on the axial end surface of the light projection side (103) of the heat dissipation member having axial and radial convection holes (101) for communicating to the axial tubular flowpath (102), and said central axial air inlet port (109) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
radially-fixed and electric-conductive interface (115): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and a radial external electric power, and connected to the LED (111) with an electric conductive member for transmitting electric power;
top cover member (116): made of a thermal conductive or non thermal conductive material, connected at the connection side (104) of the heat dissipation member having axial and radial convection holes (101) for providing insulation and protection to the heat dissipation member having axial and radial convection holes (101), or providing functions of optical reflecting or refracting or condensing or diffusing; when being made of a thermal conductive material, the top cover member (116) further provides with a function of assisting the heat dissipation of the heat dissipation member having axial and radial convection holes (101).

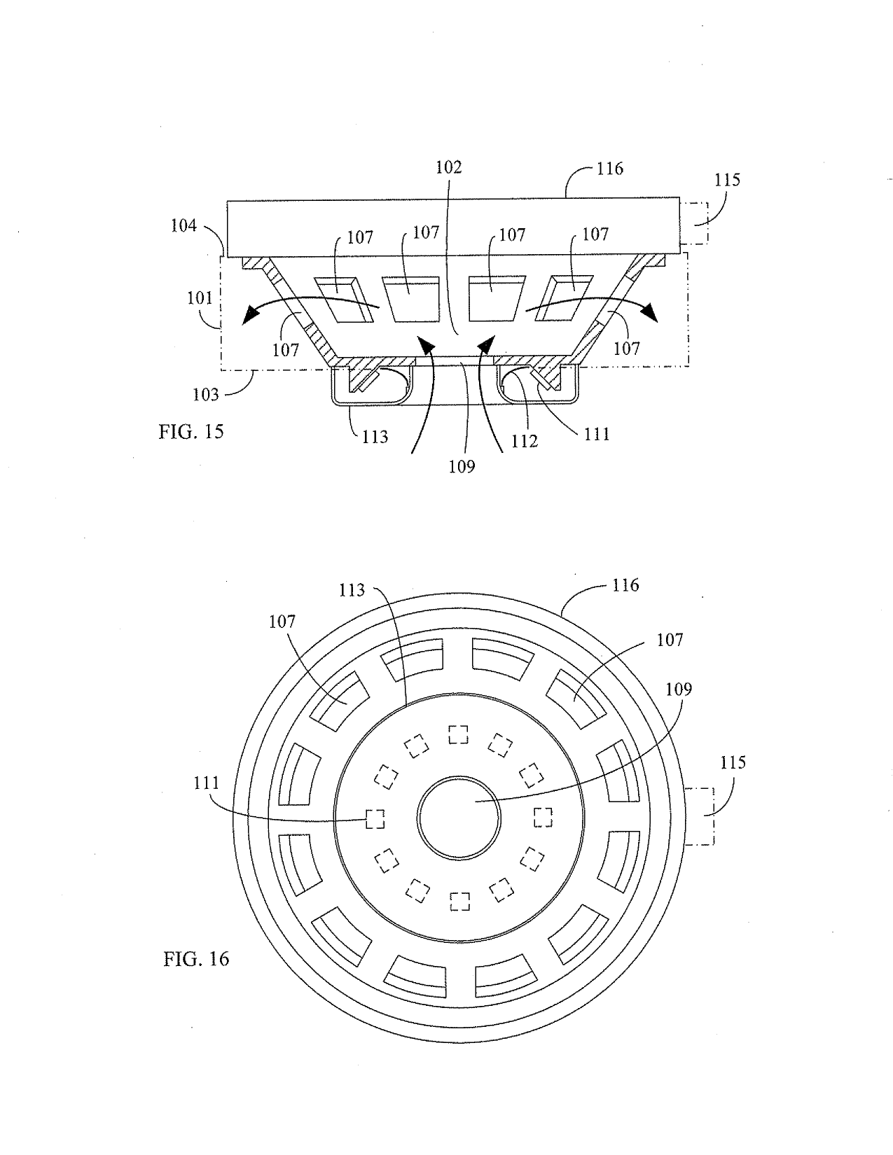

FIG. 15 is a schematic structural view illustrating the embodiment disclosed in FIG. 7 being applied in the heat dissipation member having axial and radial convection holes (101) having the top being installed with a radially-fixed and electric conductive interface (115) and installed with a top cover member (116), according to one embodiment of the present invention;

FIG. 16 is a bottom view of FIG. 15;

As shown in FIG. 15 and FIG. 16, it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;

With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the central axial air inlet port (109) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the inner periphery of the light projection side (103) of the heat dissipation member having axial and radial convection holes (101);
central axial air inlet port (109): constituted by a central axial air inlet port structure installed on the axial end surface of the light projection side (103) of the heat dissipation member having axial and radial convection holes (101) for communicating to the axial tubular flowpath (102), and said central axial air inlet port (109) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
radially-fixed and electric-conductive interface (115): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and a radial external electric power, and connected to the LED (111) with an electric conductive member for transmitting electric power;
top cover member (116): made of a thermal conductive or non thermal conductive material, connected at the connection side (104) of the heat dissipation member having axial and radial convection holes (101) for providing insulation and protection to the heat dissipation member having axial and radial convection holes (101), or providing functions of optical reflecting or refracting or condensing or diffusing; when being made of a thermal conductive material, the top cover member (116) further provides with a function of assisting the heat dissipation of the heat dissipation member having axial and radial convection holes (101).

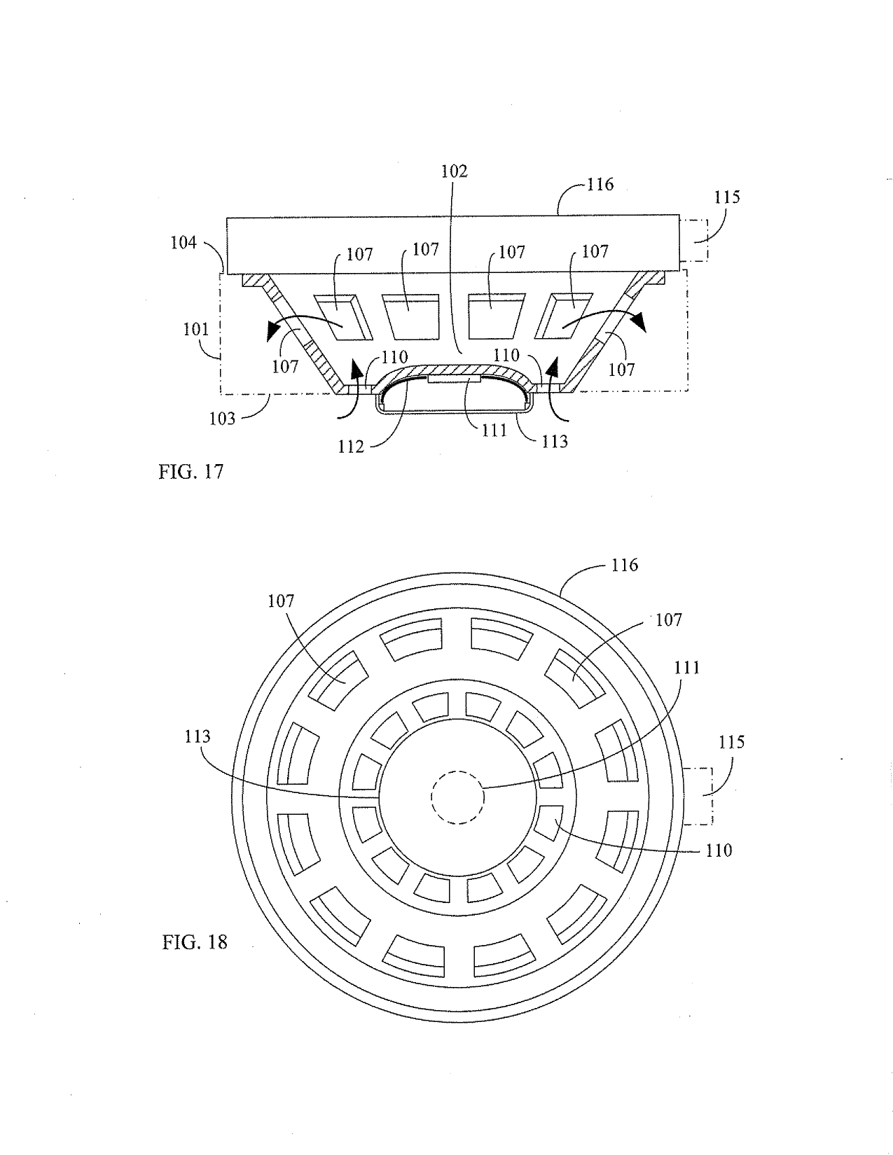

FIG. 17 is a schematic structural view illustrating the embodiment disclosed in FIG. 9 being applied in the heat dissipation member having axial and radial convection holes (101) having the top being installed with a radially-fixed and electric conductive interface (115) and installed with a top cover member (116), according to one embodiment of the present invention;

FIG. 18 is a bottom view of FIG. 17;

As shown in FIG. 17 and FIG. 18, it mainly consists of
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;

With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from one or more than one air inlet ports annularly arranged near the periphery of axial end surface (110) at the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the center of the light projection side (103) of the heat dissipation member having axial and radial convection holes (101);
air inlet port annularly arranged near the periphery of axial end surface (110): constituted by one or more than one air inlet port structures annularly installed near the periphery of axial end surface of the light projection side (103) of the heat dissipation member having axial and radial convection holes (101) for communicating to the axial tubular flowpath (102), and said air inlet port annularly arranged near the periphery of axial end surface (110) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
radially-fixed and electric-conductive interface (115): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and a radial external electric power, and connected to the LED (111) with an electric conductive member for transmitting electric power;
top cover member (116): made of a thermal conductive or non thermal conductive material, connected at the connection side (104) of the heat dissipation member having axial and radial convection holes (101) for providing insulation and protection to the heat dissipation member having axial and radial convection holes (101), or providing functions of optical reflecting or refracting or condensing or diffusing; when being made of a thermal conductive material, the top cover member (116) further provides with a function of assisting the heat dissipation of the heat dissipation member having axial and radial convection holes (101).

According to the present invention, when the LED heat dissipation device having axial and radial convection holes being further applied, air inlet ports can be installed at plural locations, wherein:
one end of the heat dissipation member having axial and radial convection holes (101) near the connection side (104) is installed with one or more than one radial air outlet holes (107), and the light projection side (103) is installed with air inlet ports, said air inlet ports are installed to at least one or more than one of three locations which include the outer periphery being installed with a radial air inlet port (108) and/or the center of axial end surface of the light projection side (103) being installed with a central axial air inlet port (109) and/or the light projection side (103) being installed with an air inlet port annularly arranged near the periphery of axial end surface (110);

According to the LED heat dissipation device having axial and radial convection holes, the shape of the axial tubular flowpath (102) is not limited to be formed in the round shape, which can be further included with an oval tubular flowpath, triangle tubular flowpath, rectangular tubular flowpath, pentagonal tubular flowpath, hexangular tubular flowpath, polygonal tubular flowpath having more than six angles, U-shaped tubular flowpath, singular-slot hole tubular flowpath with dual open ends, or multiple-slot hole tubular flowpath with dual open ends; or can be shaped to a cross section having plural angles or geometric shapes, etc., illustrated with the following embodiment:

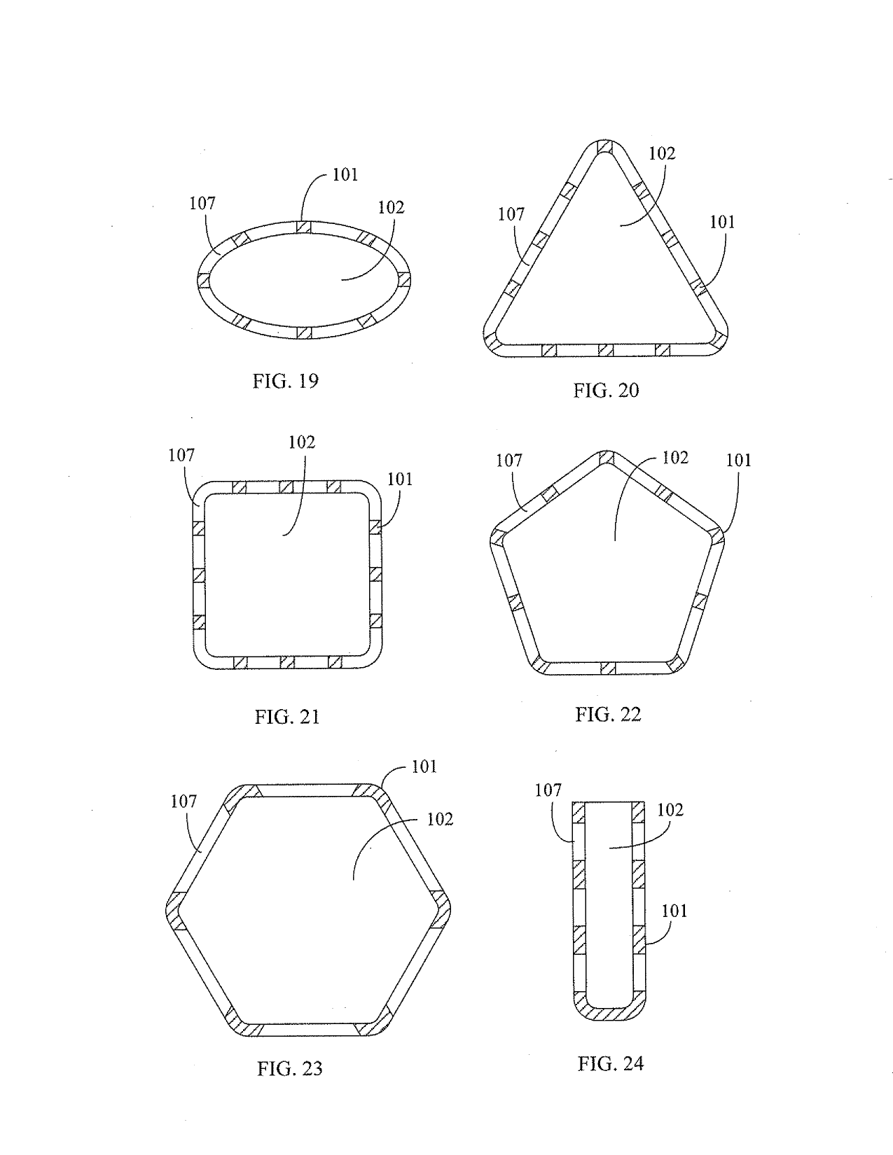

FIG. 19 is a schematic view illustrating the axial A-A cross section of the axial tubular flowpath (102) shown in FIG. 1 being formed as an oval hole, according to one embodiment of the present invention.

As shown in FIG. 19, the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the A-A cross section of the tubular flowpath is in an oval shape.

FIG. 20 is a schematic view illustrating the axial A-A cross section of the axial tubular flowpath (102) shown in FIG. 1 being formed as a triangular hole, according to one embodiment of the present invention;

As shown in FIG. 20, the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the A-A cross section of the tubular flowpath is in a triangular or triangular-like shape.

FIG. 21 is a schematic view illustrating the axial A-A cross section of the axial tubular flowpath (102) shown in FIG. 1 being formed as a rectangular hole, according to one embodiment of the present invention;

As shown in FIG. 21, the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the A-A cross section of the tubular flowpath is in a rectangular or rectangular-like shape.

FIG. 22 is a schematic view illustrating the axial A-A cross section of the axial tubular flowpath (102) shown in FIG. 1 being formed as a pentagonal hole, according to one embodiment of the present invention;

As shown in FIG. 22, the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the A-A cross section of the tubular flowpath is in a pentagonal or pentagonal-like shape.

FIG. 23 is a schematic view illustrating the axial A-A cross section of the axial tubular flowpath (102) shown in FIG. 1 being formed as a hexagonal hole, according to one embodiment of the present invention;

As shown in FIG. 23, the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the A-A cross section of the tubular flowpath is in a hexagonal or hexagonal-like shape.

FIG. 24 is a schematic view illustrating the axial A-A cross section of the axial tubular flowpath (102) shown in FIG. 1 being formed as a U-shaped hole, according to one embodiment of the present invention;

As shown in FIG. 24, the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the A-A cross section of the tubular flowpath is in a U shape with single sealed side.

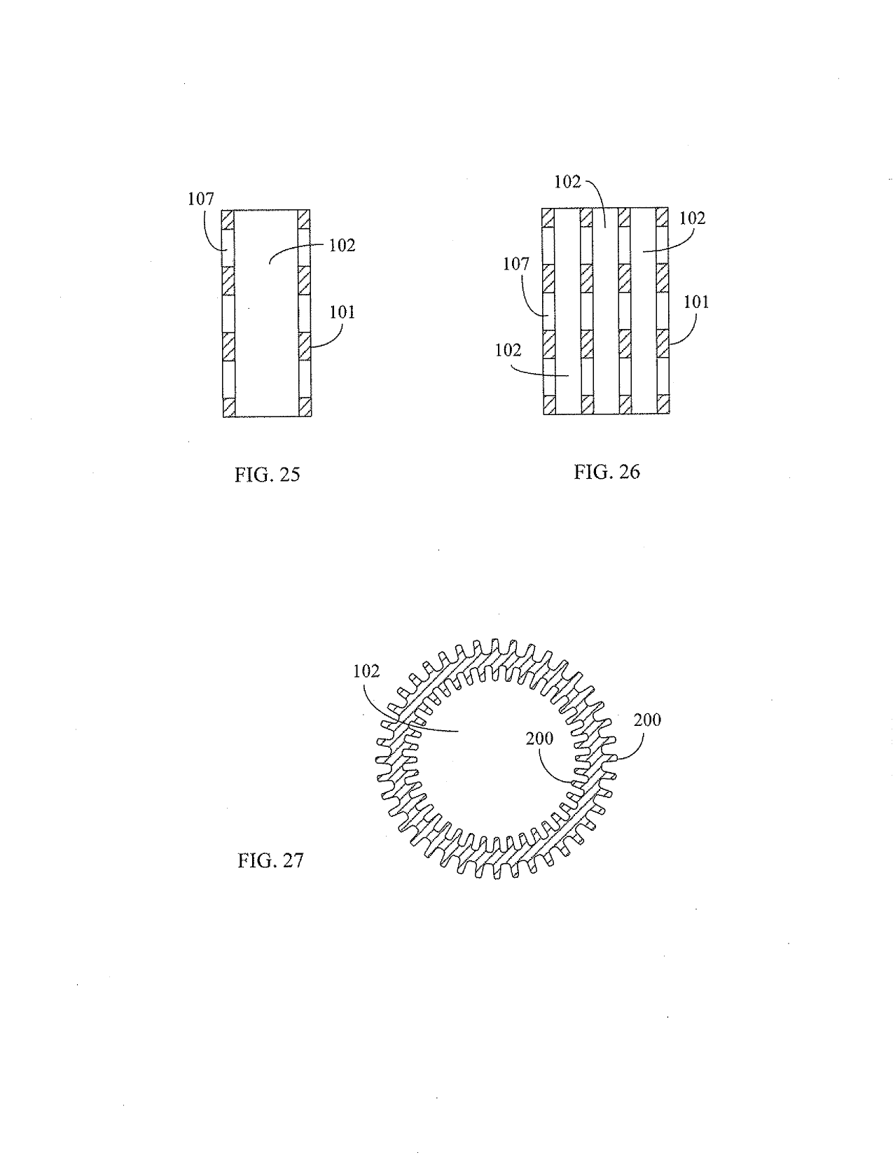

FIG. 25 is a schematic view illustrating the axial A-A cross section of the axial tubular flowpath (102) shown in FIG. 1 being formed as a singular-slot hole with dual open ends, according to one embodiment of the present invention;

As shown in FIG. 25, the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the A-A cross section of the tubular flowpath is formed as a singular-slot hole with dual open ends.

FIG. 26 is a schematic view illustrating the axial A-A cross section of the axial tubular flowpath (102) shown in FIG. 1 being formed as a multiple-slot hole with dual open ends, according to one embodiment of the present invention;

As shown in FIG. 26, the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the A-A cross section of the tubular flowpath is in formed as two or more than two slot hole with dual open ends.

According to the LED heat dissipation device having axial and radial convection holes, both or at least one of the interior and the exterior of the axial cross section of the axial tubular flowpath (102) can be provided with a heat dissipation fin structure (200) for increasing the heat dissipation effect;

FIG. 27 is a schematic view illustrating the axial B-B cross section of the axial tubular flowpath (102) shown in FIG. 1 being formed as a heat dissipation fin structure (200), according to one embodiment of the present invention;

As shown in FIG. 27, the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the B-B cross section of the tubular flowpath is formed with the heat dissipation fin structure (200).

According to the LED heat dissipation device having axial and radial convection holes, the heat dissipation member having axial and radial convection holes (101) can be further formed as a porous or net-shaped structure which is made of a thermal conductive material, and the holes of the porous structure and the net holes of the net-shaped structure can be used for replacing the radial air outlet hole (107) and the radial air inlet port (108); and the light projection side (103) is formed with a block-shaped heat conductive structure allowing the LED (111) to be installed thereon;

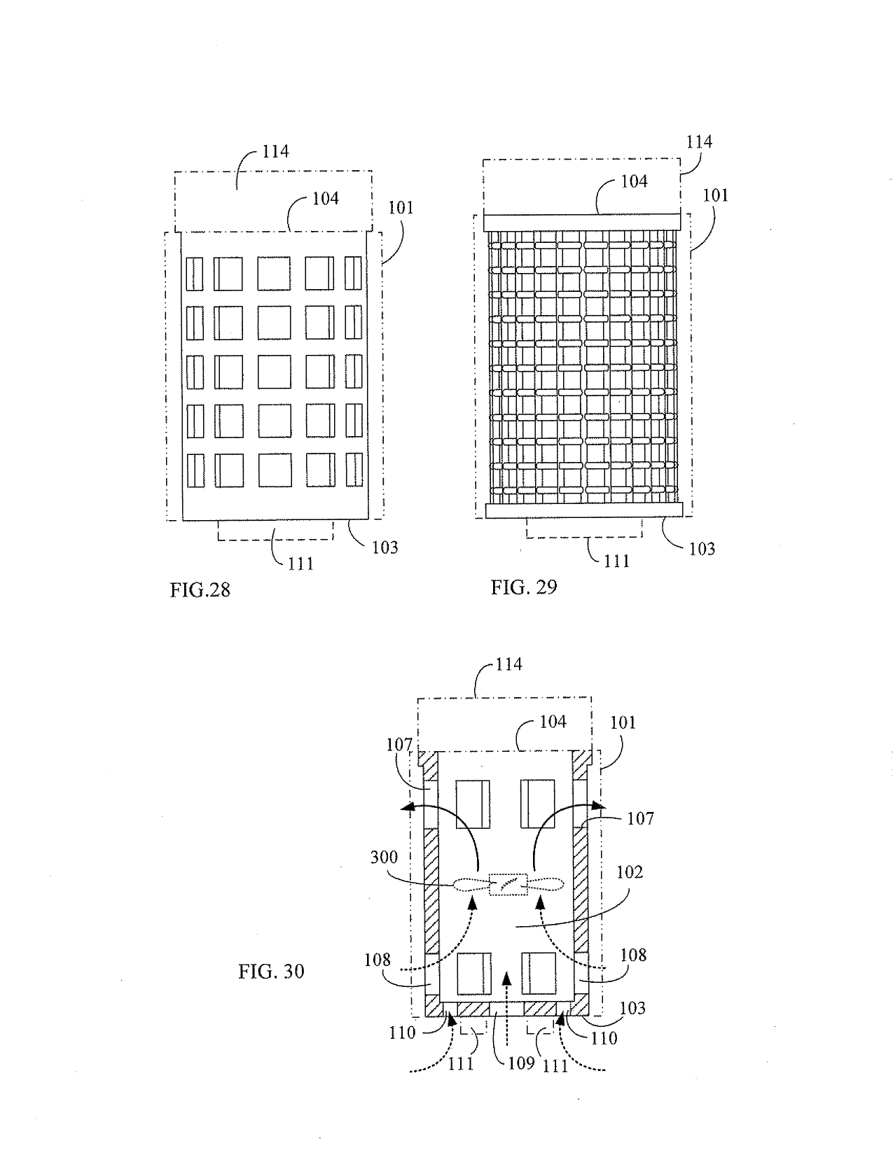

FIG. 28 is a schematic view showing the heat dissipation member having axial and radial convection holes (101) being formed as a porous structure, according to one embodiment of the present invention;

As shown in FIG. 28, in the LED heat dissipation device having axial and radial convection holes, the heat dissipation member having axial and radial convection holes (101) can be further formed as a porous structure made of a thermal conductive material, and the holes of the porous structure can be used for replacing the radial air outlet hole (107) and the radial air inlet port (108); and the light projection side (103) is formed with a block-shaped heat conductive structure allowing the LED (111) to be installed thereon;

FIG. 29 is a schematic view showing the heat dissipation member having axial and radial convection holes (101) being formed as a net-shaped structure, according to one embodiment of the present invention;

As shown in FIG. 29, in the LED heat dissipation device having axial and radial convection holes, the heat dissipation member having axial and radial convection holes (101) can be further formed as a net-shaped structure made of a thermal conductive material, and the net holes of the net-shaped structure can be used for replacing the radial air outlet hole (107) and the radial air inlet port (108); and the light projection side (103) is formed with a block-shaped heat conductive structure allowing the LED (111) to be installed thereon.

According to the LED heat dissipation device having axial and radial convection holes, the interior of the axial tubular flowpath (102) can be installed with an electric motor driven fan (300) for assisting the flowing of the hot airflow in the axial tubular flowpath (102) for increasing the heat dissipation effect;

FIG. 30 is a schematic view illustrating an electric motor driven fan (300) being provided in the interior, according to one embodiment of the present invention;

As shown in FIG. 30, in the LED heat dissipation device having axial and radial convection holes, the airflow in the axial tubular flowpath (102) not only can be driven by the hot ascent/cool descent effect, the electric motor driven fan (300) can be further installed in the axial tubular flowpath (102) for assisting the flowing of the hot airflow in the axial tubular flowpath (102), and thereby increasing the heat dissipation effect.

1. A LED heat dissipation device having axial and radial convection holes, which not only equipped with a function of dissipating heat to the exterior through the surface of the heat dissipation device, but also provided with the air flowing capable of assisting heat dissipation through the hot airflow in a heat dissipation member having axial and radial convection holes (101) generating a hot ascent/cold descent effect for introducing airflow from an air inlet port formed near a light projection side to pass an axial tubular flowpath (102) then be discharged from a radial air outlet hole (107) formed near a connection side (104) of the heat dissipation member having axial and radial convection holes (101), and it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and the light projection side (103) is installed with one or more than one air inlet ports, said air inlet ports are installed to at least one or more than one of three locations which include the outer periphery being installed with a radial air inlet port (108) and/or the center of axial end surface of the light projection side (103) being installed with a central axial air inlet port (109) and/or the light projection side (103) being installed with an air inlet port annularly arranged near the periphery of axial end surface (110);
With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the air inlet port formed near the light projection side to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior.

2. A LED heat dissipation device having axial and radial convection holes as claimed in claim 1, wherein an electric-powered light emitting unit is installed at the center of the end surface of a light projection side and a radial air inlet port (108) is formed near the outer periphery of the light projection side, and it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;
With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from one or more than one radial air inlet ports (108) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the center of the light projection side (103) of the heat dissipation member having axial and radial convection holes (101);
radial air inlet port (108): constituted by one or more than one radial air inlet ports (108) installed near the outer periphery of the light projection side (103) of the heat dissipation member having axial and radial convection holes (101), and said radial air inlet port (108) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
axially-fixed and electric-conductive interface (114): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and an axial external electric power, and connected to the LED (111) with an electric conductive member for transmitting electric power.

3. A LED heat dissipation device having axial and radial convection holes as claimed in claim 1, wherein the electric-powered light emitting unit is annularly installed near the outer periphery of the light projection side and the center is formed with a central axial air inlet port (109), and it mainly consists of
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;
With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the central axial air inlet port (109) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the outer periphery of the light projection side (103) of the heat dissipation member having axial and radial convection holes (101);
central axial air inlet port (109): constituted by a central axial air inlet port structure installed on the axial end surface of the light projection side (103) of the heat dissipation member having axial and radial convection holes (101) for communicating to the axial tubular flowpath (102), and said central axial air inlet port (109) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
axially-fixed and electric-conductive interface (114): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and an axial external electric power, and connected to the LED (111) with an electric conductive member for transmitting electric power.

4. A LED heat dissipation device having axial and radial convection holes as claimed in claim 1, wherein the electric-powered light emitting unit is annularly installed near the inner periphery of the light projection side and the center is formed with a central axial air inlet port (109), and it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;
With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the central axial air inlet port (109) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the inner periphery of the light projection side (103) of the heat dissipation member having axial and radial convection holes (101);
central axial air inlet port (109): constituted by a central axial air inlet port structure installed on the axial end surface of the light projection side (103) of the heat dissipation member having axial and radial convection holes (101) for communicating to the axial tubular flowpath (102), and said central axial air inlet port (109) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
axially-fixed and electric-conductive interface (114): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and an axial external electric power, and connected to the LED (111) with an electric conductive member for transmitting electric power.

5. A LED heat dissipation device having axial and radial convection holes as claimed in claim 1, wherein the electric-powered light emitting unit is installed at the center of the end surface of the light projection side and the light projection side is formed with an air inlet port annularly arranged near the periphery of axial end surface (110), and it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;
With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from one or more than one air inlet ports annularly arranged near the periphery of axial end surface (110) at the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the center of the light projection side (103) of the heat dissipation member having axial and radial convection holes (101);
air inlet port annularly arranged near the periphery of axial end surface (110): constituted by one or more than one air inlet port structures annularly installed near the periphery of axial end surface of the light projection side (103) of the heat dissipation member having axial and radial convection holes (101) for communicating to the axial tubular flowpath (102), and said air inlet port annularly arranged near the periphery of axial end surface (110) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
axially-fixed and electric-conductive interface (114): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and an axial external electric power, and connected to the LED (111) with an electric conductive member for transmitting electric power.

6. A LED heat dissipation device having axial and radial convection holes as claimed in claim 1, wherein a heat dissipation member having axial and radial convection holes (101) having the top is installed with a radially-fixed and electric conductive interface (115) and installed with a top cover member (116), and it mainly consists of:
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;
With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from one or more than one radial air inlet ports (108) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the center of the light projection side (103) of the heat dissipation member having axial and radial convection holes (101);
radial air inlet port (108): constituted by one or more than one radial air inlet ports (108) installed near the outer periphery of the light projection side (103) of the heat dissipation member having axial and radial convection holes (101), and said radial air inlet port (108) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
radially-fixed and electric-conductive interface (115): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and a radial external electric power, and connected to the LED (111) with an electric conductive member for transmitting electric power;
top cover member (116): made of a thermal conductive or non thermal conductive material, connected at the connection side (104) of the heat dissipation member having axial and radial convection holes (101) for providing insulation and protection to the heat dissipation member having axial and radial convection holes (101), or providing functions of optical reflecting or refracting or condensing or diffusing; when being made of a thermal conductive material, the top cover member (116) further provides with a function of assisting the heat dissipation of the heat dissipation member having axial and radial convection holes (101).

7. A LED heat dissipation device having axial and radial convection holes as claimed in claim 1, wherein the heat dissipation member having axial and radial convection holes (101) having the top is installed with a radially-fixed and electric conductive interface (115) and installed with a top cover member (116), and it mainly consists of
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;
With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the central axial air inlet port (109) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the outer periphery of the light projection side (103) of the heat dissipation member having axial and radial convection holes (101);
central axial air inlet port (109): constituted by a central axial air inlet port structure installed on the axial end surface of the light projection side (103) of the heat dissipation member having axial and radial convection holes (101) for communicating to the axial tubular flowpath (102), and said central axial air inlet port (109) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
radially-fixed and electric-conductive interface (115): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and a radial external electric power, and connected to the LED (111) with an electric conductive member for transmitting electric power;
top cover member (116): made of a thermal conductive or non thermal conductive material, connected at the connection side (104) of the heat dissipation member having axial and radial convection holes (101) for providing insulation and protection to the heat dissipation member having axial and radial convection holes (101), or providing functions of optical reflecting or refracting or condensing or diffusing; when being made of a thermal conductive material, the top cover member (116) further provides with a function of assisting the heat dissipation of the heat dissipation member having axial and radial convection holes (101).

8. A LED heat dissipation device having axial and radial convection holes as claimed in claim 1, wherein the heat dissipation member having axial and radial convection holes (101) having the top is installed with a radially-fixed and electric conductive interface (115) and installed with a top cover member (116), and it mainly consists of
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;
With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from the central axial air inlet port (109) of the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the inner periphery of the light projection side (103) of the heat dissipation member having axial and radial convection holes (101);
central axial air inlet port (109): constituted by a central axial air inlet port structure installed on the axial end surface of the light projection side (103) of the heat dissipation member having axial and radial convection holes (101) for communicating to the axial tubular flowpath (102), and said central axial air inlet port (109) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
radially-fixed and electric-conductive interface (115): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and a radial external electric power, and connected to the LED (111) with an electric conductive member for transmitting electric power;
top cover member (116): made of a thermal conductive or non thermal conductive material, connected at the connection side (104) of the heat dissipation member having axial and radial convection holes (101) for providing insulation and protection to the heat dissipation member having axial and radial convection holes (101), or providing functions of optical reflecting or refracting or condensing or diffusing; when being made of a thermal conductive material, the top cover member (116) further provides with a function of assisting the heat dissipation of the heat dissipation member having axial and radial convection holes (101).

9. A LED heat dissipation device having axial and radial convection holes as claimed in claim 1, wherein the heat dissipation member having axial and radial convection holes (101) having the top is installed with a radially-fixed and electric conductive interface (115) and installed with a top cover member (116), and it mainly consists of
heat dissipation member having axial and radial convection holes (101): made of a material having good heat conductivity and formed as an integral or assembled hollow member, and said hollow member is a sealed or semi-sealed structure, the outer radial surface is formed as a smooth surface, rib surface, grid surface, porous, net-shaped or fin-shaped structure, thereby forming an external heat dissipation surface (105); the radial interior is formed as a smooth surface, rib surface, grid surface, porous, net-shaped or fin-shaped structure, thereby forming an internal heat dissipation surface (106); the center is formed with an axial tubular flowpath (102) serving as an axial hole allowing airflow to pass, and one axial side of the heat dissipation member having axial and radial convection holes (101) is defined as a light projection side (103) allowing a LED (111) to be installed thereon, and the other axial side is defined as a connection side (104) serving as the structure for external connection;
one end of the heat dissipation member having axial and radial convection holes (101) near the connection side (104) is installed with one or more than one radial air outlet holes (107), and said radial air outlet hole (107) includes grid holes configured by a hole-shaped or net-shaped structure;
With the mentioned structure when generating heat loss during the LED (111) being electrically conducted for emitting light, the air flowing formed through the hot airflow in the heat dissipation member having axial and radial convection holes (101) generating a hot ascent/cold descent effect for introducing airflow from one or more than one air inlet ports annularly arranged near the periphery of axial end surface (110) at the light projection side (103) to pass the axial hole configured by the axial tubular flowpath (102) then be discharged from the radial air outlet hole (107) formed near the connection side (104) of the heat dissipation member having axial and radial convection holes (101), thereby discharging thermal energy in the axial tubular flowpath (102) to the exterior;
light emitting diode (LED) (111): constituted by one or more than one light emitting diodes or modules, and installed at the center of the light projection side (103) of the heat dissipation member having axial and radial convection holes (101);
air inlet port annularly arranged near the periphery of axial end surface (110): constituted by one or more than one air inlet port structures annularly installed near the periphery of axial end surface of the light projection side (103) of the heat dissipation member having axial and radial convection holes (101) for communicating to the axial tubular flowpath (102), and said air inlet port annularly arranged near the periphery of axial end surface (110) includes grid holes configured by a hole-shaped or net-shaped structure;
secondary optical device (112): provided with functions of condensing, diffusing, refracting or reflecting the optical energy of the LED (111) for projecting light to the exterior;
light-pervious lampshade (113): made of a light-pervious material, covering the LED (111) for the purpose of protecting the LED (111), and allowing the optical energy of LED (111) passing through for projecting to the exterior;
radially-fixed and electric-conductive interface (115): one end thereof is connected to the connection side (104) of the heat dissipation member having axial and radial convection holes (101), the other end is a screw-in type, insertion type or lock-on type lamp head or lamp holder structure, or an electric conductive interface structure configured by an electric conductive terminal structure, provided as a connection interface for the LED (111) and a radial external electric power, and connected to the LED (111) with an electric conductive member for transmitting electric power;
top cover member (116): made of a thermal conductive or non thermal conductive material, connected at the connection side (104) of the heat dissipation member having axial and radial convection holes (101) for providing insulation and protection to the heat dissipation member having axial and radial convection holes (101), or providing functions of optical reflecting or refracting or condensing or diffusing; when being made of a thermal conductive material, the top cover member (116) further provides with a function of assisting the heat dissipation of the heat dissipation member having axial and radial convection holes (101).

10. A LED heat dissipation device having axial and radial convection holes as claimed in claim 1, wherein when it is further applied, the air inlet ports can be installed at plural locations, and wherein
one end of the heat dissipation member having axial and radial convection holes (101) near the connection side (104) is installed with one or more than one radial air outlet holes (107), and the light projection side (103) is installed with air inlet ports, said air inlet ports are installed to at least one or more than one of three locations which include the outer periphery being installed with a radial air inlet port (108) and/or the center of axial end surface of the light projection side (103) being installed with a central axial air inlet port (109) and/or the light projection side (103) being installed with an air inlet port annularly arranged near the periphery of axial end surface (110).

11. A LED heat dissipation device having axial and radial convection holes as claimed in claim 1, wherein the shape of the axial tubular flowpath (102) is not limited to be formed in the round shape, which can be further included with an oval tubular flowpath, triangle tubular flowpath, rectangular tubular flowpath, pentagonal tubular flowpath, hexangular tubular flowpath, polygonal tubular flowpath having more than six angles, U-shaped tubular flowpath, singular-slot hole tubular flowpath with dual open ends, or multiple-slot hole tubular flowpath with dual open ends.

12. A LED heat dissipation device having axial and radial convection holes as claimed in claim 1, wherein both or at least one of the interior and the exterior of the axial cross section of the axial tubular flowpath (102) can be provided with a heat dissipation fin structure (200) for increasing the heat dissipation effect, and the main configuration is that the heat dissipation member having axial and radial convection holes (101) is made of a material having good thermal conductivity, and between the radial air outlet hole near the connection side (104) and the air inlet port near the light projection side (103), the axial tubular flowpath (102) is served as a communicated tubular flowpath, wherein the B-B cross section of the tubular flowpath is formed with the heat dissipation fin structure (200).

13. A LED heat dissipation device having axial and radial convection holes as claimed in claim 1, wherein the heat dissipation member having axial and radial convection holes (101) can be further formed as a porous or net-shaped structure which is made of a thermal conductive material, and the holes of the porous structure and the net holes of the net-shaped structure can be used for replacing the radial air outlet hole (107) and the radial air inlet port (108); and the light projection side (103) is formed with a block-shaped heat conductive structure allowing the LED (111) to be installed thereon.

14. A LED heat dissipation device having axial and radial convection holes as claimed in claim 1, wherein the heat dissipation member having axial and radial convection holes (101) can be further formed as a net-shaped structure made of a thermal conductive material, and the net holes of the net-shaped structure can be used for replacing the radial air outlet hole (107) and the radial air inlet port (108); and the light projection side (103) is formed with a block-shaped heat conductive structure allowing the LED (111) to be installed thereon.

15. A LED heat dissipation device having axial and radial convection holes as claimed in claim 1, wherein the interior of the axial tubular flowpath (102) can be installed with an electric motor driven fan (300) for assisting the flowing of the hot airflow in the axial tubular flowpath (102) for increasing the heat dissipation effect.
